(19) United States
(12) Patent Application Publication
(10) Pub. No.: US 2007/0291125 A1
(43) Pub. Date: Dec. 20, 2007

(54) Method for the Automatic Calibration of a Stereovision System

(76) Inventor: Jerome Marquet, Voisins Le Bretonneux (FR)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/573,326

(22) PCT Filed: Jun. 27, 2005
(86) PCT No.: PCT/FR05/50502

§ 371 Date: Apr. 17, 2007

(30) Foreign Application Priority Data
Aug. 11, 2004 (FR) 040881.5

(51) Int. Cl. H04N 5/225

(52) U.S. Cl. 348/207.99

(57) ABSTRACT

The invention relates to a method for the automatic calibration of a stereovision system which is intended to be disposed on board a motor vehicle. The inventive method comprises the following steps consisting in: acquiring (610) a left image and a right image of the same scene comprising at least one traffic lane for the vehicle, using a first and second acquisition device; searching (620) the left image and right image for at least two vanishing lines corresponding to two essentially-parallel straight lines of the lane; upon detection of said at least two vanishing lines, determining (640) the co-ordinates of the point of intersection of said at least two respectively-detected vanishing lines for the left image and the right image; and determining (650) the pitch error and the yaw error in the form of the intercamera difference in terms of pitch angle and yaw angle from the co-ordinates of the points of intersection determined for the left image and the right image.

The invention relates to a method for the automatic calibration of a stereovision system Intended to be carried onboard a motor vehicle.

Obstacle detection systems used in motor vehicles, integrating stereovision systems with two cameras, right and left, have to be calibrated very accurately in order to be operational. Specifically, a calibration error—that is to say an error of alignment of the axes of the cameras—of the order of ±0.1° may cause malfunctioning of the detection system. Now, such accuracy is very difficult to achieve mechanically A so-called electronic calibration procedure must therefore be envisaged which consists in determining the error of alignment of the axes of the cameras and in correcting the measurements performed on the basis of the images detected by the cameras as a function of the alignment error determined.

The known calibration procedures require the use of test patterns which have to be placed facing the stereovision system. They therefore require manual labor immobilization of the vehicle with a view to an intervention in the workshop and are all the more expensive as calibration must be performed at regular time intervals, since it is not possible to guarantee that the movements of a camera relative to another camera are less than ±0.1° in the life cycle of the motor vehicle.

The doctoral thesis from the University of Paris 6, submitted on Apr. 2, 2004 by J DOURET, proposes a calibration procedure devoid of test pattern, based on the detection on the road of ground markings and on a priori knowledge of the geometric constraints imposed on these markings (individual positions, spacing and/or global structure). This procedure turns out to be complex on the one hand on account of the fact that the application thereof presupposes that a marking having predefined characteristics be disposed within the field of vision and that the geometric constraints imposed on such a marking be codified, and on the other hand of the fact that it presupposes on the one hand that a demarcation of the lines by markings of the carriageway be available and on the other hand that a correspondence be established between the positions of several marking points, representative of the lateral and longitudinal positions of the markings, detected respectively in a right image and a left image.

The invention therefore aims to produce a method for the calibration of a stereovision system intended to be carried onboard a motor vehicle, which makes it possible to obtain a calibration accuracy of less than ±0.1°, which is simple and automatic, not requiring in particular the use of a test pattern, or human intervention, or the immobilization of the vehicle.

For this purpose, the subject of the invention is a method for the automatic calibration of a stereovision system intended to be carried onboard a motor vehicle and comprising at least two image acquisition devices, namely a first acquisition device for the acquisition of a first so-called “left” image and a second acquisition device for the acquisition of a second so-called “right” image, said method consisting in

a) acquiring in the first acquisition device and in the second acquisition device, a left image, respectively a right image, of one and the same scene comprising at least one running track for said vehicle,

b) determining the calibration error,

c) performing a rectification of the left and right images on the basis of said calibration error,

noteworthy in that step b) of said method consists in

b1) searching through said left image and through said right image for at least two vanishing lines corresponding to two straight and substantially parallel lines of the running track, in particular lines of delimitation or lines of marking of the running track,

b2) determining for the left image and for the right image, the coordinates of the point of intersection of said at least two respectively detected vanishing lines,

b3) determining the calibration error by determining the pitch error and the yaw error in the form of the intercamera difference of angle of pitch, respectively of angle of yaw on the basis of said coordinates of the intersection points determined for the left image and for the right image,

and in that said rectification of said left and right images is performed as a function of said pitch error and of said yaw error.

By running track is meant here in a broad sense both the road itself (comprising the carriageway and the verges) the carriageway alone or a running lane demarcated on a road with several lanes.

The method according to the invention exploits the fact that a running track comprises approximately parallel lines, either lines of delimitation corresponding to the edges of the running track or lines of marking of the running track. Furthermore, contrary to the prior art presented above, the marking lines do not necessarily have to be present or exhibit a redefined spacing. Finally, the determination alone of the vanishing points in the right image and in the left image makes it possible to determine the calibration error, in particular the pitch error and the yaw error.

According to a particularly advantageous embodiment, the pitch error and the yaw error are determined by assuming that the angle of roll lies in a predetermined interval, for example between −5° and +5°.

On account of the fact that the method is performed without human intervention, it may be performed repeatedly without any cost overhead, as soon as the vehicle follows a sufficiently plane running lane. Preferably the method will be performed at regular time intervals according to a predetermined periodicity. Furthermore the method does not require the immobilization of the vehicle and is adapted for being performed during the displacement of the vehicle. This guarantees for example that in the case of the mechanical “recalibration” of the cameras, the calibration may be performed again automatically and electronically as soon as the vehicle again follows a sufficiently plane running lane.

According to a particularly advantageous embodiment of the method according to the invention, the method furthermore consists:

in determining a framing of the parameters of the equations of the vanishing lines determined for the left image and for the right image;

in determining a framing of the coordinates of the vanishing points of the left image and of the right image on the basis of the framing of the parameters of the equations of the vanishing lines, and

in determining a framing of the pitch error and of the yaw error on the basis of the framing of the coordinates of the vanishing point.

Other advantages and features of the invention will become apparent in the light of the description which follows. In the drawings to which reference is made:

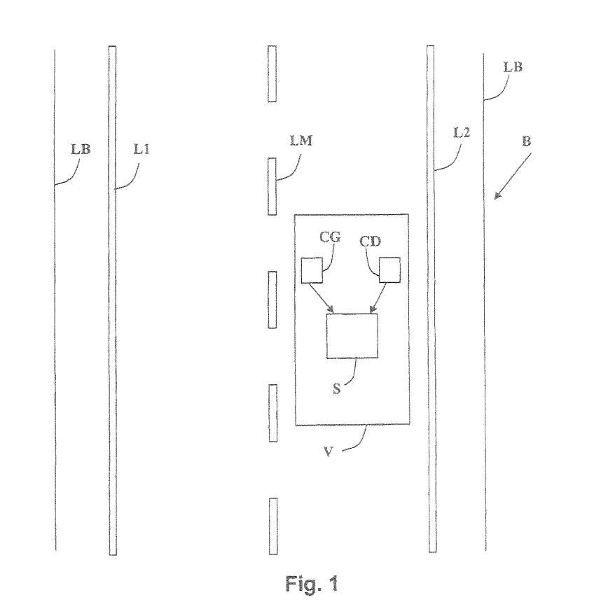

FIG. 1 is a simplified diagram of a vehicle equipped with a stereovision system;

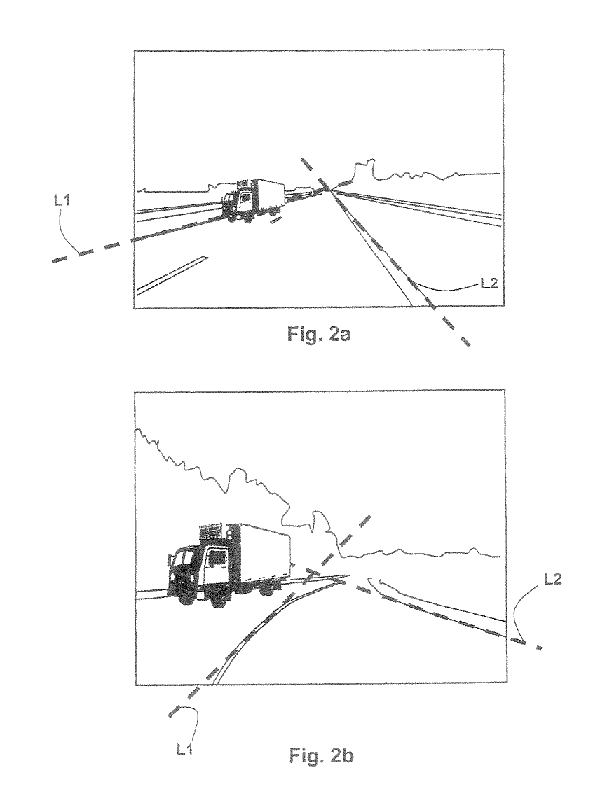

FIGS. 2a and 2b represent examples of images acquired by a camera placed in a vehicle in position on a running track;

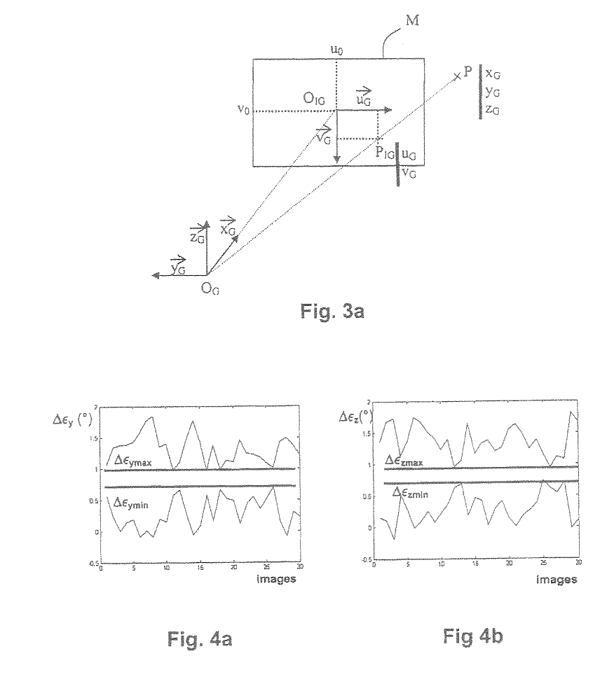

FIGS. 3a, 3b and 3c are a geometric illustration in 3 dimensions of the geometric model used in the method according to the invention;

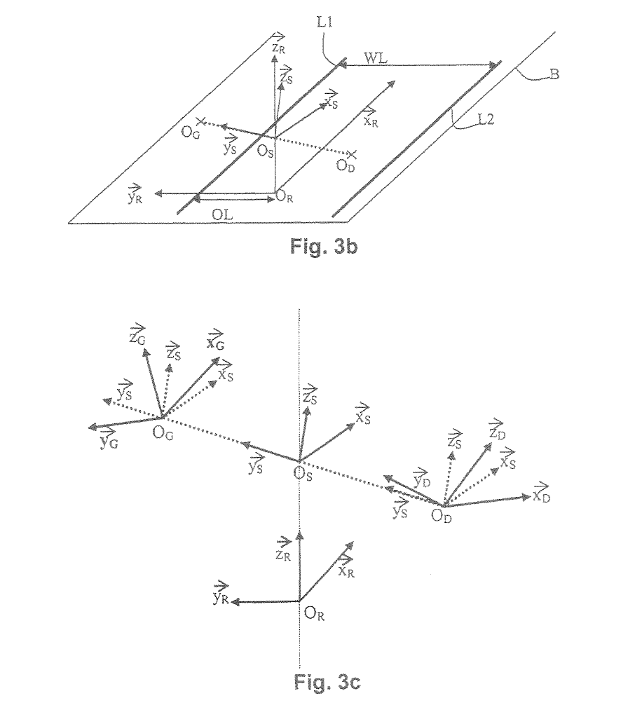

FIGS. 4a and 4b illustrate the mode of calculation of certain parameters used in the method according to the invention;

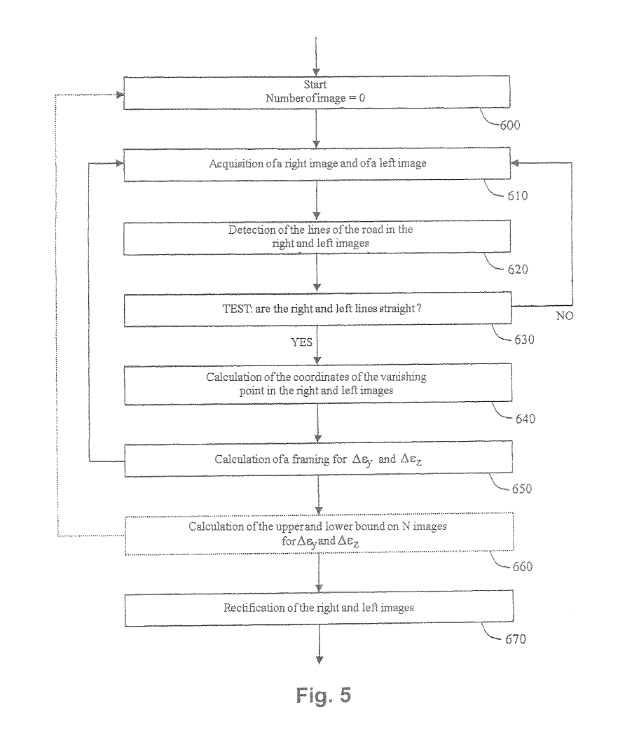

FIG. 5 is a simplified flow chart of the method according to the invention.

In what follows, as illustrated by FIG. 1, consideration will be made of a motor vehicle V, viewed from above, moving or stationary on a running track B. The running track is assumed to be approximately plane. It therefore comprises approximately parallel lines, consisting either of lines of delimitation LB of the running track itself (its right and left edges) or lateral L1, L2 or central LM marking lines. The marking lines L1 and L2 define the carriageway proper, whereas the lines L1 and LM (or L2 and LM) delimit a running lane on this carriageway. It should be noted that a marking of the road is not necessary for the execution of the method according to the invention, insofar as the edges LB of the road are useable as parallel lines, provided that they are sufficiently rectilinear and exhibit sufficient contrast with respect to the immediate environment of the road. Specifically, a brightness contrast or a colorimetric contrast, even small, may suffice to render these edges detectable on a snapshot of the road and of its immediate environment.

The vehicle is equipped with a stereovision system comprising two cameras, right CD and left CG, placed some distance apart. These cameras are typically CCD cameras allowing the acquisition of a digital image. The images are processed by a central processing and calculation system S, in communication with the two cameras and receiving the images that they digitize. The left and right images are first of all, as is usual, transformed with their intrinsic calibration parameters so as to reduce to the pinhole model in which a point of space is projected onto the point of the focal plane of the camera which corresponds to the intersection of this focal plane with the straight line joining the point of space to the optical center of the camera. (See for example chapter 3 of the document “Computer Vision, A modem approach” by Forsyth and Ponce, published by Prentice Hall). The images may thereafter form the subject after acquisition of a filtering or of a preprocessing, in such a way for example as to improve the contrast or the definition thereof, thereby facilitating the subsequent step of detecting the lines of the image.

Each camera CD and CG placed in the vehicle acquires an image such as those represented in FIG. 2a or 2b. The image 2a corresponds to a situation where the vehicle follows a rectilinear running lane. In this image, the lines L1 and L2 marking the running track are parallel and converge to the vanishing point of the image. The image 2b corresponds to a situation where the vehicle follows a bend in town. The lines L1 and L2 detectable in this image are very short straight segments.

The method according to the invention will now be described step by step with reference to FIG. 5 in combination with FIGS. 3a, 3b, 3c and 4a, 4b illustrating each of the particular aspects of the method. Steps 610 to 640 are performed exactly in the same way on the right image and on the left image, steps 650 to 670 use the results obtained in steps 610 to 640 in combination for the two images.

Detection of Straight Lines

The image acquired in step 610 by the right camera CD and corrected so as to reduce to the pinhole model for this camera CD, as well as that acquired by the left camera CG, corrected in the same way, is thereafter submitted to a lines detection step 620. For this purpose use is preferably made of a Hough transform or a Radon transform. Any other process for detecting straight lines is also useable, for example by matrix filtering, thresholding and detection of gradients in the image. The use of a Hough or Radon transform makes it possible to determine the lines present in the image and to determine moreover the number of points belonging to these lines. As a function of the number of points found, it is possible to determine whether the vehicle is in a straight line situation or in a bend. In the first case a calibration of the stereo base may be performed but not in the second.

When these lines are straight, the transform makes it possible to determine moreover the coefficients of the equations of the straight lines with an accuracy which depends on the parameterization of the transform used for the detection of the lines.

For this purpose we define for the left image acquired by the left camera and orthonormal affine reference frame R_{I}_{_{G}}=(O_{IG}, \vec{u}G−\vec{v}G)_{<} illustrated in FIG. 3a, whose origin O_{IG} with coordinates (uO, vO) is assumed to be situated at the center of the acquisition matrix (typically CCD matrix) of the camera, and whose basis vectors \vec{u}G and \vec{v}G correspond respectively to the horizontal and vertical axes of the matrix. The coordinates (uO, vO) of the reference frame R_{I}_{_{G}} are given here as a number of pixels with respect to the image matrix of the camera. Likewise for the right image we define an orthonormal affine reference frame R_{I}_{_{D}}=(O_{ID}, \vec{u}D·\vec{v}D). It is assumed here for the sake of simplification that the dimensions of the two acquisition matrices right and left are identical. The coordinates (uO, vO) of the center of each right and left matrix are therefore also identical.

In such a reference frame a straight line has equation:
(u−u₀)cos θ−(v−v₀)smθ=ω (1)
where θ and ω are the parameters characterizing the slope and the ordinate at the origin of the straight line.

Each straight line equation determined with the aid of the Hough or Radon transform therefore corresponds to a value of θ and a value of ω. According to the parameterization of the transform used, it is possible to determine for each straight line detected a framing of these two values of parameters.

For the first straight line LD1 of the right image corresponding to a straight line L1 of the running track, we obtain the following framings for the values Θ_{D}_{¹} and ω_{Di} of θ and of ω:
θ_{D1min≦}θ_{DX}≦θ_{D1max} (2)
ωₘₘₙ≦ω_{D1}≦ω_{D1}_{_{π}}ₐₓ (3)
and for the second straight line LD2 of the right image corresponding to a straight line L2 of the running track we obtain the following framing values Θ_{D2} and ω_{D2} of θ and of ω:
θₘₘₘ≦θ_{D2}≦θₘₘₐₓ (4)
ω_{D2mm}≦ω_{D2}≦ω_{D2πax} (5)

Likewise, for the first straight line LG1 of the right image corresponding to the straight line L1 of the running track, we obtain the following framings for the values θ_{C}_{¹} and ω_{G1} of θ and of ω:
θ_{C1min}≦θ_{G1}≦θ_{G1max} (6)
α_{>G1 π}_{^{u}}ₙ≦_{Û>G1}≦_{Û>G1.mx} (7)

For the second straight line LG2 of the right image corresponding to the straight line L2 of the running track, we obtain the following framings for the values Θ_{G2} and ω_{C2} of θ and of ω:
θ_{C2min}≦θ_{G2}≦θ_{C2max} (8)
ω_{C2m,n≦}ω_{G2}≦_{<%2m<<} (9)

In order to eliminate situations of the type of that of FIG. 2b where the vehicle follows a nonrectilinear lane portion and where the portions of straight lines detected are inappropriate to the accurate determination of the vanishing point in the image, we retain only those straight lines of the image for which a sufficient number of points is obtained. A test step 630 is therefore performed on each of the straight lines detected so as to eliminate the portions of straight lines comprising two few points and to determine whether for at least two straight lines in the image the number of points is greater than a threshold. This threshold is fixed in an empirical manner or is the result of experiments on a succession of characteristic images. When no straight line or portion of straight line possesses a sufficient number of points, the following steps of the method are not performed and we return to image acquisition step 610. When at least two straight lines possess a sufficient number of points, we retain in each of these right and left images only two straight lines, for example the two straight lines possessing the most points in each image then we go to the next step 640.

Determination of the Vanishing Point

For each right and left image we determine the coordinates of the vanishing point, that is to say the coordinates of the intersection of the two straight lines retained.

On the basis of the notation and equations defined above, the point of intersection with coordinates (U_{D}F·V_{DF}) of the straight lines LD1 and LD2 in the right image is defined by the following relations:

$$\begin{matrix}{u}_{DF} = {u}_{0} + \frac{{ω}_{D 2} sin {θ}_{D 1} - {ω}_{D 1} sin {θ}_{D 2}}{cos {θ}_{D 1} sin {θ}_{D 2} - cos {θ}_{D 2} sin {θ}_{D 1}} & ( 10 ) \\ {v}_{DF} = {v}_{0} + \frac{{ω}_{O 2} cos t {9}_{p} , - {ω}_{D 1} Cos f {1}_{D 2}}{cos {θ}_{D 1} sin {θ}_{D 2} - cos {Θ}_{D 2} sin {θ}_{D 1}} & ( 11 )\end{matrix}$$

where θ_{D1}, ω_{D1}, Θ_{D1} and ω_{D2} vary respectively in the intervals defined by relations (2) to (5).

From the framing values determined previously we therefore determine by searching for the maximum and for the minimum of U_{DF} and V_{DF} given by relations (10) and (11) where Θ_{D1}, ω_{D1}, Θ_{D2} and ω_{D2} vary in the intervals defined by relations (2) to (5), a framing of the coordinates (U_{DF}>V_{DF}) of the vanishing point in the right image in the form:
^{<<}Dmₘ≦^{U}DF^{≦}>>Dmax (12)
v_{Dmn}≦v_{DF}≦v_{Dmax} (13)

Likewise, the point of intersection with coordinates (U_{GF}, V_{GF}) of the straight lines LG1 and LG2 in the left image is defined by the following relations:

$$\begin{matrix}{u}_{GF} = {u}_{0} + \frac{{ω}_{G 2} sin f {1}_{{G}^{2}} - {ω}_{{{G}^{2}}^{{SJ}^{iI}}} {θ}_{0 \; 2}}{cos {θ}_{G i} sin {Θ}_{G 2} - cos {Θ}_{G 2} sin {θ}_{Ci}} & ( 14 ) \\ {v}_{GF} = {v}_{0} + \frac{{ω}_{{G}^{2}} cos {θ}_{G i} - {ω}_{ω} cos {θ}_{G 2}}{cos {Θ}_{{G}^{1}} sin {Θ}_{G 2} - cos {Θ}_{G 2} sin {Θ}_{G 1}} & ( 15 )\end{matrix}$$

where θ_{G1}, ω_{Gi}, Θ_{G1} and ω_{G2} vary in the intervals defined by relations (6) to (9).

Likewise for the right image, we determine for the coordinates (U_{GF}, V_{GF}) of the vanishing point of the left image, a framing in the form:
<<G-≦^{U}GF≦″Cmax (16)
v_{Gmin≦}v_{GF}≦v_{Gm.x} (17)

The search for a minimum or for a maximum is performed for example by varying in the various intervals the various parameters involved, for example, in steps of 0.1 or 0.05 units for θ and ω. Other mathematical analysis techniques can of course be used, in particular by calculation of derivatives.

Geometrical Model

Before proceeding with the description of the determination of the calibration errors, the geometrical model used will be described with reference to FIGS. 3a, 3b and 3c.

The geometrical model used is based on a plurality of right-handed orthonormal reference frames which are defined in three-dimensional space in the following manner:

let O_{G}, respectively O_{D} be the optical center of the left camera, respectively the optical center of the right camera;

let Os be the middle of the segment [O_{G}, O_{D}]; we denote by B the distance from O_{G} to O_{D};

let R_{G}=(O_{G}, \vec{x}_{G}, \vec{y}G. \vec{z}_{G})^{′e} be the intrinsic reference frame of the left camera such that \vec{u}G and \vec{y}G, on the one hand, and \vec{v}_{G} and \vec{z}_{G}, on the other hand, are colinear; the difference between R₁_{_{G}} and R_{G} consists in that in R_{G} the coordinates are given in metric units (m, mm, for example) and not as a number of pixels;

let R_{D}=(O_{D}, \vec{x}D, \vec{y}_{D}, \vec{z}_{D}) be the intrinsic reference frame of the right camera;

let RR=(O_{R}, \vec{x}_{R}, \vec{y}_{R}, \vec{z}_{R}) be the so-called road reference frame or running track reference frame, the vector \vec{x}_{R} being parallel to the straight lines L1 and L2 belonging to the plane of the road, the vector \vec{y}_{R} being parallel to the plane of the road and perpendicular to the direction defined by \vec{x}_{R}, and the point O_{R} being situated in the plane of the road and at the vertical defined by \vec{z}_{R} of the point Oₛ, such that
{right arrow over (_{O}_{^{R}}Oₛ)}=ₕ\vec{Z_{R}} (18)

let Rₛ=(Os, \vec{x}s, \vec{y}s, \vec{z}s)^{′e} be the stereo reference frame, the vector \vec{y}s being colinear with the straight line passing through the points O_{G}, Oₛ and O_{D} and oriented from the point Oₛ to the point O_{G}, the vector \vec{x}ₛ being chosen perpendicular to \vec{y}s and colinear to the vector product of the vectors \vec{z}_{G} and \vec{z}_{D}:

We then define the following change of reference frame matrices:

the transform making it possible to switch from the reference frame R_{R} to the reference frame R_{S}, which is the composition of three rotations of respective angles σₓᵣ, a_{yr}, a_{zr} and of respective axes \vec{x}_{R}, \vec{y}_{R}, \vec{z}_{R}, is defined by the angles {σₓᵣ, σ_{yr}, σ_{zr}} and corresponds to the following change of reference frame matrix MT_{SR}:

$${MR}_{SR} - \begin{matrix}( \begin{matrix}cos {α}_{y r} cos {α}_{{z}_{r}} & - cos {α}_{y r} sin {α}_{zr} & sin {α}_{> r} \\ cos {α}_{xr} sin {α}_{{z}_{r}} + sin {α}_{xr} sin {a}_{{y}_{r}} cos {α}_{{z}_{r}} & cos α {⪡}_{tr} cos {α}_{- r} - sin {⪡}_{{x}_{r}} sin {α}_{{y}_{r}} sin {α}_{{z}_{r}} & - sin {α}_{xr} cos {α}_{y r } \\ sin {α}_{tr} sin {α}_{{z}_{r}} - cos {α}_{{x}_{r}} sin {α}_{{y}_{r}} cos {a}_{zr} & sin {α}_{xr} cos {α}_{{z}_{r}} + cos {α}_{{x}_{r}} sin {a}_{> r} sin {a}_{{z}_{r}} & cos {or}_{tr} cos {α}_{> r}\end{matrix} )\end{matrix} \qquad ( 19 )$$

so that the coordinates (xₛ, yₛ, zₛ) of a point M in Rₛ are calculated on the basis of these coordinates (x_{R}, y_{R}, z_{R}) in R_{R} in the following manner:

$$( \begin{matrix}{x}_{S} \\ {y}_{S} \\ {z}_{S}\end{matrix} ) = {MR}_{SR} ( \begin{matrix}{x}_{R} \\ {y}_{R} \\ {z}_{R} - h\end{matrix} ) \qquad ( 20 )$$

the transform making it possible to switch from the reference frame R_{S} to the reference frame R_{G}, which is the composition of three rotations of respective angles e_{xg}, ε_{yg}, e_{zg} and of respective axes \vec{x}_{G}, \vec{y}_{G}, \vec{z}_{G} is defined by the angles {ε_{xg}, ε_{yg}, e_{zg}} and corresponds to the following change of reference frame matrix MR_{G}s:

$${MR}_{CS} = \begin{matrix}( \begin{matrix}cos {ɛ}_{> g} cos {ɛ}_{zg} & - cos {ɛ}_{yg} sin {ɛ}_{zg} & sin {ɛ}_{yg} \\ cos {ɛ}_{xg} sin {ɛ}_{zg} + sin {ɛ}_{xg} sin {ɛ}_{yg} cos {ɛ}_{zg} & cos {ɛ}_{xg} cos {ɛ}_{zg} - sin {ɛ}_{xg} sin {ɛ}_{yg} sin {ɛ}_{zg} & - sin {𝔷}_{xg} cos {ɛ}_{yg } \\ sin {ɛ}_{xg} sin {ɛ}_{zg} - cos {ɛ}_{xg} sin {ɛ}_{> g} cos {ɛ}_{zg} & sin {ɛ}_{tg} cos {ɛ}_{zg} + cos {ɛ}_{xg} sin {ɛ}_{yg} sin {ɛ}_{zg} & cos {ɛ}_{xg} cos {ɛ}_{yg}\end{matrix} )\end{matrix} \qquad ( 21 )$$

so that the coordinates (x_{G}, y_{G}, z_{G}) of a point M in R_{G} are calculated on the basis of the coordinates (xₛ, ys, zₛ) in Rₛ in the following manner:

$$( \begin{matrix}{x}_{G} \\ {y}_{G} \\ {z}_{G}\end{matrix} ) = {MR}_{GS} ( \begin{matrix}{x}_{S} \\ {y}_{S} + B / 2 \\ {z}_{S}\end{matrix} ) \qquad ( 22 )$$

the transform making it possible to switch from the reference frame Rₛ to the reference frame R_{D}, which is the composition of three rotations of respective angles ε_{xd}, ε_{yd}, e_{z}α and of respective axes \vec{x}_{D}, \vec{y}_{D}, \vec{z}_{D} is defined by the angles {ε_{xd}, ε_{yd}, e_{zd}} and corresponds to the following change of reference frame matrix MR_{D}s:

$$( \begin{matrix}cos {ɛ}_{y Λ} cos {ɛ}_{zd} & - cos {ɛ}_{y d} sin {ɛ}_{zd} & SUI {ɛ}_{y d} \\ cos 𝔷 {\text{-}}_{xd} sin 𝔷 {\text{-}}_{zd} + sin {𝔷}_{xd} sin {ɛ}_{y d} cos {ɛ}_{zd} & cos {ɛ}_{xd} cos {ɛ}_{zd} - sin {ɛ}_{xd} sin {ɛ}_{> d} sin 𝔷 {\text{-}}_{zd} & - sin {ɛ}_{xd} cos 𝔷 {\text{-}}_{> d } \\ sin {ɛ}_{xd} sin {ɛ}_{zd} - cos {ɛ}_{xd} sin {ɛ}_{y d} cos {𝔷}_{zd} & sin {ɛ}_{xd} cos {ɛ}_{zd} + cos {ɛ}_{x Λ} sin {ɛ}_{y d} sin {ɛ}_{zd} & cos 𝔷 {\text{-}}_{xd} cos {ɛ}_{y d}\end{matrix} ) \qquad ( 23 )$$

so that the coordinates (x_{D}, y_{D}, z_{D}) of a point M in R_{D} are calculated on the basis of its coordinates (xₛ, ys, Zₛ) in Rₛ in the following manner:

$$( \begin{matrix}{x}_{D} \\ {y}_{D} \\ {z}_{D}\end{matrix} ) = {MR}_{DS} ( \begin{matrix}{x}_{S} \\ {y}_{S} + BI2 \\ {z}_{S}\end{matrix} ) \qquad ( 24 )$$

Moreover, from relations (20) and (22) we deduce that the coordinates (x_{G}, y_{G}, z_{G}) of a point M in R_{G} are calculated on the basis of its coordinates (x_{R}, y_{R}, z_{R}) in R_{R} in the following manner:

$$( \begin{matrix}{x}_{G} \\ {y}_{G} \\ {z}_{G}\end{matrix} ) = {MR}_{GS} {MR}_{SR} ( \begin{matrix}{x}_{R} \\ {y}_{R} \\ {z}_{R} - h\end{matrix} ) + {MR}_{GS} ( \begin{matrix}0 \\ - B / 2 \\ 0\end{matrix} ) \qquad ( 25 )$$

Likewise, from relations (20) and (24) we deduce that the coordinates (x_{D}, V_{D}−z_{D}) of a point M in R_{D} are calculated on the basis of its coordinates (x_{R}, y_{R}, z_{R}) in R_{R} in the following manner:

$$( \begin{matrix}{x}_{D} \\ {y}_{D} \\ {z}_{D}\end{matrix} ) = {MR}_{DS} {MR}_{SR} ( \begin{matrix}{x}_{R} \\ {y}_{R} \\ {z}_{R} - h\end{matrix} ) + {MR}_{DS} ( \begin{matrix}0 \\ B / 2 \\ 0\end{matrix} ) \qquad ( 26 )$$

We put moreover, by definition of the apparent angles {θ_{xg}, θ_{yg}, 0_{zg}} of roll, pitch and yaw for the left camera with respect to the reference frame of the road:

$${MR}_{GS} {MR}_{SR} = ( \begin{matrix}cos ( {9}_{> g} cos 6 > {,}_{g} & - cos {θ}_{yg} sin 0 {,}_{g} & sin \# {,}_{yg} \\ cos {\#}_{τ g} sin {\#}_{zg} + sin {?}_{τ g} sin {\#}_{yg} cos {\#}_{zg} & cos {θ}_{τ g} cos {θ}_{zg} - sin {\#}_{cg} sin {θ}_{yg} sin {θ}_{zg} & - sin {θ}_{τ g} cos {θ}_{yg} \\ sin ( {9}_{tg} sin {θ}_{zg} - cos {θ}_{yg} sin {θ}_{yg} cos 6 ) ) {,}_{g} & sin ( {9}_{τ g} cos {θ}_{zg} + cos < {9}_{τ g} sin {θ}_{y g} sin {θ}_{2 g} & cos ( {9}_{rg} cos {θ}_{yg}\end{matrix} ) \qquad ( 27 )$$

and by definition of the apparent angles {θ_{xd}, θ_{yd}, θ_{zd}} of roll, pitch and yaw for the right camera with respect to the reference frame of the road:

$${MR}_{DS} {MR}_{SR} = ( \begin{matrix}cos < {?}_{y d} cos 6 {>}_{z0} & - cos {0}_{y d} sin {\#}_{xd} & sine {?}_{\neq } \\ cos {θ}_{xd} sin {θ}_{- d} + sin {θ}_{τ d} sin {θ}_{yu} cos θ {,}_{d} & cos {θ}_{xd} cos θ {,}_{d} - sin {θ}_{xd} sin {θ}_{> d} sin {θ}_{: d} & - sin {θ}_{τ d} cos {θ}_{y d} \\ sin {θ}_{xd} sin θ {,}_{d} - cos {θ}_{xd} sin {θ}_{y d} cos {θ}_{zd} & sin {θ}_{xd} cos {θ}_{zd} + cos {θ}_{xd} sin {θ}_{y d} sin {θ}_{: d} & cos {θ}_{xd} cos {θ}_{y d}\end{matrix} ) \qquad ( 28 )$$

Furthermore, given that the internal calibration parameters of the cameras have been used in step 610 to reduce to the pinhole model, the coordinates (u_{G}, v_{G}) of the projection in the left image of a point M with coordinates (x_{G}, y_{G}, z_{G}) in R_{G} are calculated on the basis of (x_{G}, y_{G}, z_{G}) in the following manner:
u_{G}≅U₀−kᵤfy_{G}/x_{G} (29)
v_{G}=V₀−kᵥfz_{G}/x_{G} (30)
where kᵤ is the number of pixels per mm in the image and f the focal length of the camera. For the sake of simplification, the focal lengths and number of pixels per mm are assumed here to be identical for both cameras.

With the same assumptions for the right camera, the coordinates (u_{D}, v_{D}) of the projection in the right image of a point M with coordinates (x_{D}, y_{D}, z_{D}) in R_{D} are calculated on the basis of (x_{D}, Y_{D}, z_{D}) in the following manner:
U_{D}=uₒ−kᵤfy_{D}/x_{D} (31)
v_{D}=V₀−kᵥfz_{D}/x_{D} (32)
Determination of the Pitch Error and Yaw Error

The calibration errors, given as an angle, relating to the deviation of each of the axes of the reference frame of the left or right camera with respect to the stereo reference frame Rₛ, are denoted respectively ε_{xg}, ε_{yg} and ε_{zg}. For the right camera, these same errors are denoted respectively ε_{xd}, ε_{yd} and ε_{zd}. Within the context of this invention, we are interested in determining the calibration error of the stereoscopic system in the form of a pitch error Δe_{y}, defined here as being the intercamera difference of pitch angle:
Δe_{y}=ε_{yg}−ε_{yd} (33)
and in the form of a yaw error Ae_{z}, defined here as being the intercamera difference of yaw angle:
Δε₂=ε_{zg}−e_{z\dot{a}} (34)

It is these two errors which have the greatest influence on the errors of measurement of distance and of displacement of the epipolar lines which serve as basis for the rectification procedure.

In this determination of the pitch error and yaw error, it is assumed that the apparent angle of roll of each camera is small, typically less in absolute value than 5°. This assumption is sensible, insofar as even in a particularly tight bend, the angle of roll should not exceed 5°. Furthermore this assumption makes it possible as will be described, to calculate the apparent errors of pitch and of yaw, that is to say of the plane of the road with respect to the reference frame of the camera. However, the apparent pitch error and yaw error vary little with the apparent angle of roll. As a result it is possible to determine the apparent pitch and yaw errors with high accuracy with the help of an approximate knowledge of the angle of roll.

The knowledge of the pitch error and yaw error Δε_{y} and Δε_{z}, makes it possible to carry out a rectification of the right image or of the left image, so as to reduce to the case of a well-calibrated stereovision system, that is to say such that the axes of the right and left cameras are parallel. This rectification procedure consists, in a known manner (see for example the document already cited entitled “Computer vision, a modem approach”, Chapter 11), replacing the right and left images arising from the uncalibrated stereovision system, by two equivalent right and left images comprising a common image plane parallel to the line joining the optical centers of the cameras. The rectification usually consists in protecting the original images into one and the same image plane parallel to the line joining the optical centers of the cameras. If a coordinate system is chosen appropriately, the epipolar lines become moreover through the method of rectification the horizontal lines of the rectified images and are parallel to the line joining the optical centers of the cameras. The rectified images are useable in a system for detecting obstacles by stereovision, which generally presupposes and therefore requires that the axes of the right and left cameras be parallel. In case of calibration error, that is say when the axes of the cameras are no longer parallel, the epipolar lines no longer correspond to the lines of image required, the distance measurements are erroneous and the detection of obstacles becomes impossible.

With the help of the framing of the position of the vanishing point in the right image and in the left image, it is possible, as will be demonstrated hereinafter, to determine a framing of the pitch error Δε_{y}, and the yaw error Δε_{z} in the form:
Δε_{ymin}<Δε_{y}<Δ6_{ymax} (35)
and
Δε_{zmin}<Ae_{z}<Δε_{zmax} (36)

This framing is determined for a pair of right and left images in step 650 before returning to the image acquisition step 610.

According to a particularly advantageous embodiment of the method according to the invention, the determination of the framing of the pitch error Δε_{y} and the yaw error Δe_{z} is repeated for a plurality of images. Then, in step 660 are determined, for this plurality of images, the minimum value (or lower bound) of the values obtained for each of the images for Δε_{ymax} and Δε_{zmax}, as well as the maximum value (or upper bound) of the values obtained for Δε_{ymin} and Δε_{zmin}. This ultimately yields a more accurate framing in the form:
max{Δε_{ymin}}<Δε_{y}<min{Δε_{ymax}} (37)
and
max{Δε_{zmin}}<Δε_{z}<min{Δε_{zmax}} (38)
where the functions “min” and “max” are determined for said plurality of images. FIGS. 4a and 4b illustrate how Δε_{ymin}, respectively Δε₂ₘᵢₙ, (given in °) vary for a succession of images and how we deduce the minimum and maximum values determined for this plurality of images. It turns out that the framing obtained in this way is accurate enough to allow the rectification of the images captured and the use of the images thus rectified by the procedure according to the invention in an obstacle detection procedure. It has been verified in particular that by choosing step sizes of 0.5° and of 1 pixel for the Hough transform, we obtain a framing of Δε_{y} to within ±0.15° and a framing of Δε_{z} to within ±0.1°.

In a final step 670, the pitch and yaw errors obtained in step 660 or 650 are used to perform the rectification of the right and left images.

In what follows, the process for determining the framings of relations (35) and (36) will be explained. It should be noted that the steps described hereinafter are aimed chiefly at illustrating the approximation process. Other mathematical equations or models may be used, since, with the help of a certain number of appropriately made approximations and assumptions, we obtain a number of unknowns and a number of mathematical relations such that the determination of the pitch error Δε_{y} and the yaw error Δε_{z} is possible with the help solely of the coordinates of the vanishing points of the right and left image.

The angles {e_{xg}, ε_{yg}, ε_{zg}} and {e_{xd}, e_{yd}, ε_{zd}} being assumed small, typically less than 1°, relations (21) and (23) may be written with a good approximation:

$$\begin{matrix}{MR}_{GS} = ( \begin{matrix}1 & - {ɛ}_{z g} & {ɛ}_{yg} \\ {ɛ}_{zg} & 1 & - {ɛ}_{x g} \\ - {ɛ}_{yg} & {ɛ}_{x g} & 1\end{matrix} ) \\ and & ( 39 ) \\ {MR}_{DS} = ( \begin{matrix}1 & - {ɛ}_{zd} & {ɛ}_{y d} \\ {ɛ}_{zd} & 1 & - {ɛ}_{xd} \\ - {ɛ}_{y d} & {ɛ}_{x d} & 1\end{matrix} ) & ( 40 )\end{matrix}$$

With the help of the matrices MR_{GS}, MR_{DS} and MR_{SR} we determine the matrix ΔMR such that:
AMR=(MR_{GS}−MR_{DS})MR_{SR}

The coefficient of the first row, second column of this matrix ΔMR is
ΔMR(1,2)=
−(cos αᵣ cos a_{zr}−s\dot{m}aₓᵣ sin a_{yr} sin a_{zr})Δε_{z}
+(smaₓᵣ cos a_{zr}+cos aₓᵣ sin a_{>r}siRa_{zr})Aε_{y} (41)
and the coefficient of the first row, third column of this matrix ΔMR is
ΔM/?(1,3)=sin aₓᵣ cos a_{yr}As_{z}+cos aₓᵣ cos a_{yr}Aε_{y} (42)

Assuming that the angles {σₓᵣ, σ_{yr}, σ_{zr}} are sufficiently small, typically less than 5°, we can write:
AMR(1,2)≈−Aε (43)

By combining relations (43) and (44) with relations (27) and (28) we thus obtain an approximation of the pitch error and of the yaw error in the form:
Aε_{y}≈sin θ_{>g}−sin θ_{>d} (45)
Aε_{:}≈−cos ∂_{yg} sin ∂_{zg}+cos θ_{yd} sin θ_{za}. (46)

With the help of relations (25) and (27) we calculate the ratio

$$\frac{{y}_{G}}{{x}_{G}}$$

as a function of (x_{R}, y_{R}, z_{R}) for a point M with coordinates (x_{R}, y_{R}, z_{R}) belonging to a straight line in the plane of the road, parallel to the marking lines L1 and L2, with equations z_{R}=0, y_{R}=a and xᵣ arbitrary. By making x_{R} tend to infinity, we determine the limit of the ratio

$$\frac{{y}_{G}}{{x}_{C}}$$

which corresponds to the value of the ratio

$$\frac{{y}_{G}}{{x}_{G}}$$

determined at the vanishing point (U_{G}=U_{GF}>VG=V_{G}F·XG=XGF, VG=y_{GF}·ZG=ZGF) of the left image. By comparing this limit with the application of relations (29) and (30) to the coordinates of the vanishing point, we deduce the following relations:

$$\begin{matrix}{f}_{{}^{′} B} = \frac{{y}_{GF}}{{x}_{GF}} = \frac{{u}_{0} - {u}_{GF}}{{k}_{u} f} = \frac{Cos {θ}_{xg} Sin {θ}_{zg} + Sin {θ}_{xg} Sin {θ}_{yg} Cos {θ}_{zg}}{Cos {θ}_{yg} Cos {θ}_{zg}} \\ and & ( 47 ) \\ {f}_{{}^{′} S} = \frac{{2}_{GF}}{{X}_{G} F} = \frac{v ⪢ - {v}_{GF}}{Kf} = \frac{Sin {θ}_{xg} Sin {θ}_{zg} - Cos {θ}_{xg} Sin {θ}_{yg} Cos {θ}_{2 g}}{Cos {θ}_{yg} Cos {θ}_{2 g}} & ( 48 )\end{matrix}$$

From relations (47) and (48) we deduce the values of θ_{yg} and θ_{zg} as a function of f_{ug} and f_{vg} and of θ_{xg}:
θ_{yg}=A tan(f_{U}g sin θ_{X}g+f_{vg} Cos θ_{xg}) (49)
θ_{zg}=A tan {Cos θ_{yg}*(f_{ug}−Sin θ_{Xg} Tan θ_{yg})/Cos θ_{xg}} (50)

In the same way for the right image, we obtain for the vanishing point of the right image the following relations:

$$\begin{matrix}{f}_{ud} = \frac{{y}_{DF}}{{x}_{DF}} = \frac{uo - {u}_{DF}}{{k}_{u} f} = \frac{Cos {θ}_{xd} Sin {θ}_{zd} + Sin {θ}_{xd} Sin {θ}_{y d} Cos {θ}_{zd}}{C θ s {θ}_{y d} C θ s {θ}_{zd}} \\ and & ( 51 ) \\ {f}_{{v}_{u}} = \frac{{z}_{DF}}{{x}_{DF}} = \frac{{v}_{0} - {v}_{DF}}{{k}_{v} f} = \frac{Sin {θ}_{xd} Sin {θ}_{zd} - Cos {θ}_{xd} Sin {θ}_{y d} Cos {θ}_{zd}}{Cos {θ}_{y d} Cos {θ}_{zd}} & ( 52 )\end{matrix}$$

and from relations (51) and (52) we deduce the values of θ_{yd} and θ_{zd} as a function of f_{ud} and f_{vd} and of θ_{xd}:
θ_{yd}=A tan(f_{ud} Sin θ_{xd}+f_{vd} Cos θ_{xd}) (53)
θ_{zd}=A tan {Cos θyₛ*(f_{ud}−Sin θ_{xd} Tan θ_{yd})/Cos θ_{xd}} (54)

To summarize, the pitch error and yaw error are such that
Aε_{y}≈sin θ_{yg}−sin θ_{yd} (55)
Δε_{:}≈−cos θ_{yg} sin θ_{:g}+cos θ_{yd} sin θ_{d} (56)
where:
θ_{yg}=A tan(f_{ug} Sin θ_{xg}+f_{vg} Cos θ_{xg}) (57)
θ_{zg}=A tan {Cos θ_{yg}*(f_{Ug}−Sin θ_{xg} Tan θ_{yg})/Cos θ_{xg}} (58)
θ_{yd}=A tan(f_{ud} Sin θ_{xd}+f_{vd} Cos θ_{xd}) (59)
θ_{zd}=A tan {Cos θ_{yd}*(f_{ud}−Sin θ_{xd} Tan θ_{yd})/Cos θ_{xd}} (60)
with:

$$\begin{matrix}{J}_{ud} = \frac{{U}_{0} - {U}_{DF}}{{k}_{u} f} & ( 61 ) \\ {f}_{vd} = \frac{{v}_{0} - {v}_{DF}}{{k}_{v} f} & ( 62 ) \\ {f}_{ug} = \frac{{u}_{0} - {u}_{GF}}{{k}_{uj}} & ( 63 ) \\ Λ , = \frac{{v}_{0} - {v}_{GF}}{{k}_{v} f} & ( 64 )\end{matrix}$$

To determine the framings of the pitch error and yaw error according to relations (25) and (26), we determine the minimum and maximum values of Δε_{y} and Ae_{z} when θ_{xg} and θ_{xd} vary in a predetermined interval [−A, A], for example [−5°, +5°] and when u_{DF}, v_{DF}, u_{GF} and v_{GF} vary in the intervals defined by relations (12), (13), (16), (17). Any mathematical method for searching for a minimum and maximum is appropriate for this purpose. The simplest consists in varying in sufficiently fine steps the various parameters in the given intervals respectively and in retaining the minimum or the maximum of the function investigated each time.

It should be noted that in relations (55) to (64), the coordinates of the origins of the various orthonormal affine reference frames or their relative positions are not involved. The determination of the pitch error and yaw error by the method according to the invention is therefore independent of the position of the car on the running track.

1-13. (canceled)

14. A method for automatic calibration of a stereovision system configured to be carried onboard a motor vehicle and including at least a first acquisition device for acquisition of a first left image and a second acquisition device for acquisition of a second right image, the method comprising:
a) acquiring in the first acquisition device and in the second acquisition device, a left image and a right image, respectively, of a same scene including at least one running track for the vehicle;
b) determining a calibration error;
c) performing a rectification of the left and right images based on the calibration error;
the determining b) comprising:
b1) searching through the left image and through the right image for at least two vanishing lines corresponding to two straight and substantially parallel lines of the running track, lines of delimitation, or lines of marking of the running track,
b2) determining for the left image and for the right image, coordinates of a point of intersection of said at least two respectively detected vanishing lines,
b3) determining the calibration error by determining pitch error and yaw error in a form of intercamera difference of angle of pitch, respectively, of angle of yaw based on the coordinates of the intersection points determined for the left image and for the right image,
and the rectification of the left and right images is performed as a function of the pitch error and of the yaw error.

15. The method as claimed in claim 14, wherein the determining b3) determines a first framing between a minimum value and a maximum value of a value of the pitch error and of the yaw error.

16. The method as claimed in claim 14, further repeating the acquiring a), the searching b1), the determining b2) and the determining b3) for a plurality of left and right images, and determining a second framing of a value of the pitch error and of the yaw error based on first framings obtained for the plurality of left and right images.

17. The method as claimed in claim 16, wherein the second framing includes a maximum value of a set of minimum values obtained for the first framing of a value of the pitch error and of the yaw error, and a minimum value of the set of maximum values obtained for the first framing of the value of the pitch error and of the yaw error.

18. The method as claimed in claim 14, wherein the searching b1) determines a framing of parameters of equations of the vanishing lines for the left image and for the right image.

19. The method as claimed in claim 18, wherein the determining b2) determines a framing of the coordinates of vanishing points of the left image and of the right image based on the framing obtained in the searching b1).

20. The method as claimed in claim 19, wherein the determining b3) determines a framing of the pitch error and of the yaw error based on the framing obtained in the determining b2).

21. The method as claimed in claim 14, wherein the determining b3) is performed by assuming that an angle of roll for the right and left cameras lies in a predetermined interval, or less in absolute value than 5°, and by determining a maximum and minimum error the pitch error and of the yaw error obtained when the angle of roll varies in the interval.

22. The method as claimed in claim 14, wherein the determining b3) is performed by assuming that the errors of pitch and of yaw are small, or less in absolute value than 1°.

23. The method as claimed in claim 14, wherein the vanishing lines are detected with aid of a Hough transform.

24. The method as claimed in claim 14, wherein the vanishing lines are detected with aid of a Radon transform.

25. The method as claimed in claim 14, further comprising correcting the right and left images after acquisition so as to reduce to a pinhole model for the first and second image acquisition devices.

26. The method as claimed in claim 14, further performing the determining b2) and the determining b3) only when a number of points belonging to each of the vanishing lines detected in the searching b1) is greater than a predetermined threshold value.
